(19) United States
(12) Patent Application Publication
(10) Pub. No.: US 2020/0192012 A1
(43) Pub. Date: Jun. 18, 2020

(54) LIGHT GUIDE

(71) Applicant: MAS Innovation (Private) Limited, Colombo (LK)

(72) Inventors: Vivek Ramchandrani, Colombo (LK); Ranil VITHARANA, Colombo (LK); Ishan CHATHURANGA, Colombo (LK); Kalana BAMUNUARACHCHI, Colombo (LK); Anushka DARSHANA, Colombo (LK); Kosala LAYA SUNDARA, Colombo (LK)

(73) Assignee: MAS Innovation (Private) Limited, Colombo (LK)

(21) Appl. No.: 16/067,737

(22) PCT Filed: Jan. 4, 2017
(86) PCT No.: PCT/SG2017/050005

§ 371 Date: Oct. 4, 2018

(30) Foreign Application Priority Data
Jan. 4, 2016 (SG) 10201600010P

(51) Int. Cl. F21V 8/00

(52) U.S. Cl. CPC G02B 6/001; G02B 6/0065; G02B 6/0055; A41D 27/00; G02B 6/0041; G02B 6/0073; G02B 6/0083; G02B 6/0051

(57) ABSTRACT

There is provided a use of a silicone polymer or a polyurethane polymer composition as a light guide affixed to a flexible and stretchable substrate and a light guide device that has a flexible and stretchable substrate, one or more light sources and a flexible and stretchable light guide element, wherein the light guide is: an elongated material that has a first end and a second end distal to the first end that is attached to the substrate, the first end is adjacent to or covers at least one of the one or more light sources; and made from a substance that comprises a silicone polymer or a polyurethane polymer.

### FIELD OF INVENTION

This invention relates to a stretchable and/or flexible light guide that guides/transfers light from a point/linear light source through the guide to a distal point and which may be illuminated and glowing throughout. In particular, this invention describes a stretchable, flexible and printable silicone based light guide with special chemistry developed to ensure uniform light output while maintaining a good efficiency of light transfer. The invention also includes the integration of said light guide onto a flexible, stretchable substrate.

### BACKGROUND

The listing or discussion of an apparently prior-published document in this specification should not necessarily be taken as an acknowledgement that the document is part of the state of the art or is common general knowledge.

As the field of wearable technology has grown, one of the areas of particular interest is the integration of light sources into a garment. However, while an individual point source or lighting strip may provide light to a specific area of a garment, it is often desirable to extend this, lighting effect over a larger area and/or to have the light source fitted in one place, but supply a point of light at a point distal to the attachment of the light source to the garment. To date, the only, effective means to do this makes use of non-stretchable materials, such as electroluminescent sheets, light guides made from fibre optical cables or light guides made using polymers such as acrylonitrile butadiene styrene and poly(methyl methacrylate). Problems with such lighting systems are that they do not provide a large degree of flexibility and stretchability, which can hamper the movement of a wearer of a garment fitted with such technology or make the garment bulky and uncomfortable to wear. Given this, the above solutions tend to be fitted to areas that are not required to undergo extremes of movement, but even then they may be unsuitable for use on thin garments.

Therefore, there remains a need for improved systems to guide the light through a device.

### SUMMARY OF INVENTION

In a first, aspect of the invention, there is provided a use of a silicone polymer or a polyurethane polymer composition as a light guide affixed to a flexible and stretchable substrate, wherein the polymer is selected from the group consisting of a silicone polymer, a polyurethane polymer and a polymethylmethacrylate polymer (e.g. a silicone polymer or a polyurethane polymer).

In a second aspect of the invention, there is provided a light guide device comprising:
a first flexible and stretchable substrate;
one or more light sources; and
a first flexible and/or stretchable light guide element, wherein

the light guide is:
an elongated material, that has a first end and a second end distal to the first end, that is attached to the first substrate, the first end is adjacent to and/or covers at least one of the one or more light sources; and
made from a substance that comprises a polymer, wherein the polymer is selected from the group consisting of a silicone polymer, a polyurethane polymer and a polymethylmethacrylate polymer (e.g. a silicone polymer or a polyurethane polymer).

In embodiments of the invention:
(i) the one or more light sources may be encapsulated by the flexible and stretchable light guide element, optionally the one or more light sources may further comprise a flexible printed circuit board that is at least partly encapsulated along with the light source by the light guide (e.g. fully encapsulated);
(ii) the substance that forms the light guide element may further comprise one or more materials that form inclusions in the silicone or polyurethane polymer, optionally wherein the density of the inclusions may increase proportionately with the distance from a light source; and/or the light guide element is demarcated into a number of contiguous bands, each band having zero or more of the inclusions, optionally wherein the bands have identical dimensions and the density of the inclusions for each band increases across successive bands;
(iii) the light guide includes defects or holes, optionally wherein the density of the defects or holes increases proportionately with the distance from a light source;
(iv) a surface of the light guide element not attached to the first substrate may comprise one or more pits or channels (e.g. grooves), optionally wherein the density of the pits or channels may increase proportionately with the distance from a light source;
(v) the light source may be selected from one or more of the group consisting of a neon light source, a light emitting diode (LED), an organic light emitting diode (OLED) and an electroluminescent material (e.g. the light source is a LED or more particularly an OLED;
(vi) the light source may be a visible light source;
(vii) the light guide device may further comprise a light reflective substrate or a light reflective base material affixed to the substrate and between the first substrate and the light guide element;
(viii) the light guide may further comprise a reflective coating material across at least part of the elongated material of the light guide element, optionally wherein the reflective coating material is a polymethylmethacrylate polymer or, more particularly, a silicone polymer or a polyurethane polymer having a refractive index less than the material coated;
(ix) the light guide element may be made of a silicone or polyurethane polymer that has the property of total internal reflection;
(x) the light guide element may be made of a silicone or polyurethane polymer that has the property of light scattering along the entire length of the elongated material of the light guide element;
(ix) at least part of at least one surface of the light guide element may be covered by a diffusion material, optionally wherein the diffusion material is selected from the group consisting of a silicone polymer, a polyurethane polymer and a polymethylmethacrylate polymer that further comprises one or more holes, inclusion members, defects, pits and channels;
(x) the light guide element may be permanently attached to the first flexible and stretchable substrate, optionally wherein the permanent attachment is selected from direct attachment means and apparatus (e.g. bonding to the first substrate by adhesive or through curing, stitching, and direct integration into a yarn used in the manufacture of the first flexible and stretchable substrate) and, indirect attachment means and apparatus (e.g. loops, embroidered stitches, and pockets) or the light guide element may be removably attached to the first flexible and stretchable substrate, optionally wherein the removable attachment is selected from one or more of the group consisting of a pocket to accommodate the light guide element, and fabric loops;
(x) the first substrate may be a fabric or textile (e.g. the fabric or textile forms the whole or part of a household decoration, furniture or, more particularly, a garment, a toy, an electronic device, or a vehicle lighting system, optionally wherein the light guide device does not restrict the movement of a wearer of a garment and/or cause the wearer any discomfort);
(xi) the device may further comprise a second flexible and stretchable substrate and an attachment means or apparatus to affix the first flexible and stretchable substrate to the second flexible and stretchable substrate, optionally wherein the second flexible and stretchable substrate is a fabric or textile, optionally wherein the fabric or textile forms the whole or part of a household decoration, furniture or, more particularly, a garment, a toy, an electronic device, or a vehicle lighting system; and/or the means or apparatus are complementary snap-fit devices on respective surfaces of the first and second flexible and stretchable substrates;
(xii) the device is capable of being washed at least up to 30 times (e.g. at least up to 50 times, such as at least up to 100 times, for example from 30 to 150 times, such as from 40 to 100 times) without affecting the function of the light guide element.

In yet further embodiments of the invention, the cross-section of the light guide element may be selected from one or more of the group consisting of quadrilateral, qualtrilateral with one or more curved edges, semi-circular, semi- or partly-elliptical, and cruciform. In certain embodiments, the cross-section may be distorted by the formation of at least one peak on a surface that is not attached to the first substrate. Alternatively or additionally when the cross-section is cruciform, the light guide element oscillates in a repeating cruciformal pattern, such that a cruciform cross-section taken at a first point of the repeating pattern is offset compared to a cross-section taken at a second point of the repeating pattern.

In yet still further embodiments, the light guide element may have:
(a) a stretchability of from 0 to 300%; and/or
(b) a thickness of from 0.5 mm to 100 mm; and/or
(c) a width of greater than or equal to 0.5 mm.

In yet further embodiments, the silicone polymer may have a refractive index of from 1.30 to 1.60, optionally from 1.35 to 1.55, such as from 1.40 to 1.42. In yet still further embodiments, the silicone polymer may be a poly[oxy(dimethylsilylene)] polymer (PDMS; poly(dimethylsiloxane) polymer), optionally wherein one or more methyl groups are replaced by trifluoropropyl groups or phenyl groups.

In a third aspect of the invention there is provided a method of making a light guide device of the second aspect of the invention and/or any technically sensible combination of its embodiments, which method comprises attaching a flexible and stretchable light guide element to a first flexible and stretchable substrate by one or more of stitching, 3D knit based tunnelling or, more particularly, screen printing, stencil application, injection molding, pour molding, and direct extrusion.

When one or more of defects, holes, pits or channels are present in the light guide, they may be introduced to the light guide by the use of one or more of the group selected from laser etching, laser cutting, milling, and die cutting.

### DRAWINGS

Some embodiments of the present invention are described more fully hereinafter with reference to the accompanying drawings. In the drawing figures, dimensions may be exaggerated for clarity of illustration. Like reference numerals refer to like elements throughout.

FIG. 1A depicts in plan view a light guide device of the current invention.

FIG. 1B depicts in perspective view a further light guide device of the current invention.

FIG. 2 depicts a yet further light guide device according to the current invention.

FIG. 3 depicts in perspective view a light guide element for use as part of a light guide device of the current invention.

FIG. 4 depicts a longitudinal cross-section of the light guide element depicted in FIG. 3.

FIG. 5A depicts a longitudinal cross-section of the light guide element depicted in FIG. 3 and a light source, as well as a possible flow of light through said light guide element.

FIG. 5B depicts a longitudinal cross-section of a further light guide element.

FIG. 6 depicts transverse cross sections of possible light guide elements that may be used in the current invention.

FIG. 7A depicts in exploded perspective view the integration of a light guide element onto a first substrate in accordance with embodiments of the current invention.

FIG. 7B depicts in exploded perspective view the integration of a light guide device onto a first substrate in accordance with embodiments of the current invention.

FIG. 8A depicts in plan view a further method of integrating a light guide device onto a first substrate in accordance with embodiments of the current invention.

FIG. 8B depicts in plan view yet further methods of integrating a light guide device onto a first substrate in accordance with embodiments of the current invention.

FIG. 9A depicts in longitudinal cross section a light guide device in accordance with the current invention.

FIG. 9B depicts a perspective view of the light guide device of FIG. 9A.

FIG. 9C depicts in longitudinal cross section yet a further a light guide device in accordance with the current invention.

FIG. 10 depicts a light guide element suitable for use in embodiments of the current invention.

FIG. 11 depicts a light guide device of the current invention and a second substrate.

FIGS. 12A and 12B depict light guide devices of the current invention.

FIG. 13 depicts a light guide having a core of silicone and a coating of silicone with differing refractive indexes, thereby providing total internal reflection.

FIG. 14 depicts a light guide element having a specific pattern of inclusions according to an embodiment of the current invention.

FIG. 15 depicts portions of a light guide element according to a further embodiment of the current invention.

### DESCRIPTION

In the following detailed description, only certain embodiments of the present invention have been shown and described, simply by way of illustration. As those skilled in the art would realise, the described embodiments may preferably be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “attached to” another element, it can be directly attached to the another element or be indirectly attached to the another element with one or more intervening elements interposed therebetween. Hereinafter, like reference numerals refer to like elements.

An important prerequisite for wearable technology is unobtrusive integration. This means that the original textile properties should be preserved even when the wearable technology functionality has been added to the garment. This means that the wearable technological features added have to be very thin and flexible to allow unobtrusive integration. In addition, the resulting garments should withstand routine use and cleaning. This may include hand- or machine-washing, as well as waterless washing (e.g. dry cleaning), self-washing garments and the like.

It has been surprisingly found that a polymer composition can be used as a light guide affixed to a flexible and stretchable substrate, where the polymer in the composition is a polymethylmethacrylate polymer or, more particularly, a silicone polymer or a polyurethane polymer. The resulting light guide device has the advantage of not affecting the material characteristics of the flexible and stretchable substrate.

When discussed herein, “silicone polymer” may refer to any suitable stretchable and/or flexible silicone polymer that can be attached to a stretchable and/or flexible substrate, provided that it has the ability to act as a waveguide for light. It will be appreciated that the ability to act as a waveguide for light implies that the silicone polymer used is transparent to at least one or more wavelengths of light in the electromagnetic spectrum (e.g. transparent to whole or part of the visible light spectrum). A silicone polymer that may be mentioned herein is poly[oxy(dimethylsilylene)] polymer, which typically has a refractive index of from 1.40 to 1.42. A further silicone polymer that may be mentioned herein is a poly[oxy(dimethylsilylene)] polymer where a methyl group in some of the dimethylsilylene repeating units of the polymer has been replaced by a phenyl group, which may lead to a polymer having a refractive index of from 1.40 to 1.60, such as from 1.44 to 1.55. Yet a further silicone polymer that may be mentioned herein is a poly[oxy(dimethylsilylene)] polymer where a methyl group in some of the dimethylsilylene repeating units of the polymer has been replaced by a trifluoropropyl group, which may lead to a polymer having a refractive index of from 1.30 to 1.42, such as from 1.35 to 1.39.

FIG. 1A depicts a light guide device 100 that has a flexible and stretchable substrate 110, and one or more light sources 120. In the figure depicted, there are six light sources 120, though it will be appreciated that only one is needed. The light guide device 100 also contains a flexible and/or stretchable light guide element 130 that is made of an elongated material that has two ends distal to one another. In FIG. 1 both ends encapsulate two light sources 120. In addition, the central portion of the light guide also encapsulates two further light sources 120 as well. It will be appreciated that the light sources used in this embodiment may be arranged to provide light along the light guide in one direction (e.g. the light sources 120 at the ends of the light guide element 130) or in two directions (e.g. the light sources in the middle of the light guide element 130) to ensure light propagation along the length of the light guide element. This flexibility may be more pronounced in longer light guides, especially if there are elements within the light guide that can cause light scattering and/or diffusion elements attached to the light guide to affect such scattering, thereby reducing the intensity of light as one travels further from the light source. Embodiments containing such features will be discussed in further detail below.

In order to provide the desired properties for a light guide fitted to a flexible and stretchable substrate, the light guide element is made from a substance that comprises a polymethylmethacrylate polymer or, more particularly, a silicone polymer or a polyurethane polymer. In particular embodiments of the invention that may be mentioned herein, the light guide element may be made from a substance that comprises a silicone polymer.

FIG. 1B displays a perspective view of a similar light guide device 100 to that disclosed in FIG. 1A, but having two light sources 120 encapsulated within the light guide element 130 instead of six. This light guide element is attached to a flexible and stretchable substrate (not shown) as discussed hereinbefore. In this embodiment, the light sources 120 are fully encapsulated within the light guide element 130, as is part of a flexible printed circuit board 140. It will be appreciated that this part-encapsulation allows the remainder of the flexible circuit board to contact a power source for the light sources, whether directly or indirectly (e.g. by way of one or more conductive paths). Alternatively, it will be appreciated that the flexible printed circuit board 140 may be fully encapsulated within the light guide element 140. In this case, the flexible printed circuit board may be in direct contact with a power source that is also encapsulated within the light guide element, or it may be in indirect contact with the power source via one or more conductive paths, which are partly encapsulated within the light guide element 130.

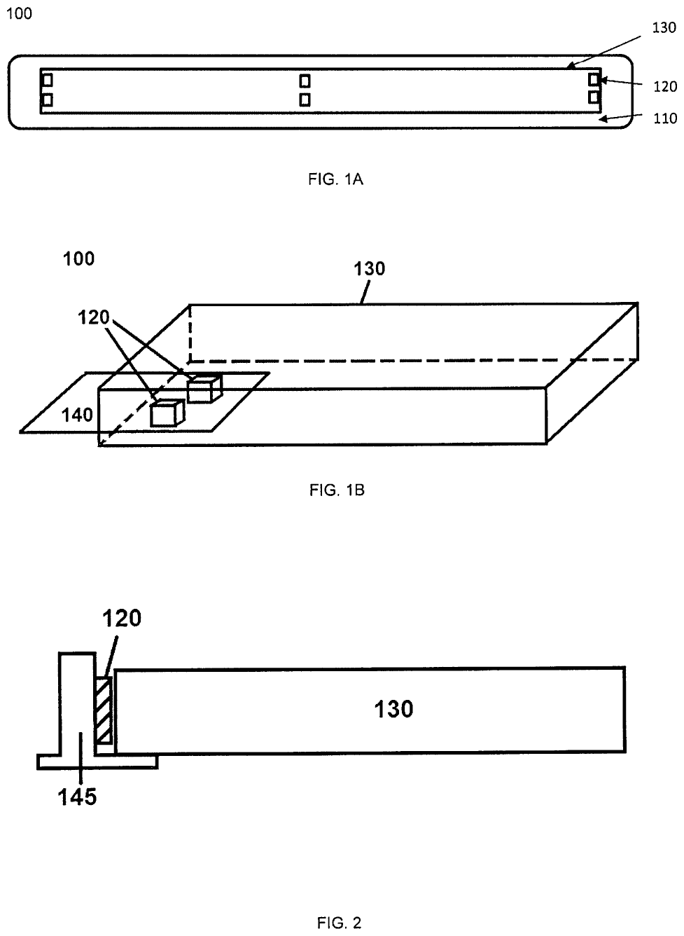

Based on the discussion above with respect to the embodiments of FIG. 1, it will be appreciated that a single light source is all that is required and that the light source does not need to be encapsulated by the light guide element and may simply be adjacent to the light guide element, such that light from the light source enters and travels through the light guide element. This is shown in FIG. 2, which provides a side-view of a further embodiment of the invention. As depicted in FIG. 2, there can be a single light source 120 adjacent to the light guide element 130, which is held in a light-propagating position by a stand-like printed circuit board 145.

The light source may be selected from one or more of the group consisting of a neon light source, a light emitting diode (LED), an organic light emitting diode (OLED) and an electroluminescent material. When used herein, “LED” refers to all types of LEDs unless specifically specified otherwise. For example, when the phrase “the group consisting of a neon light source, a light emitting diode (LED), an organic light emitting diode (OLED) and an electroluminescent material” is used, it will be understood that “LED” relates to all types of LED except for OLEDs. When used herein, “OLED” refers to all kinds of OLEDs.

It is note that the light guide device of the current invention may be capable of being washed at least up to 30 times (e.g. at least up to 50 times, such as at least up to 100 times) without affecting the function of the light guide element within the light guide device as described herein. In terms of a upper limit, the light guide device may be able to withstand 200 washes, such as 150 or 100 washes. As such, the light guide device may be able to withstand washing from 30 times to 200 times, such as from 30 times to 150 times, such as from 40 to 100 times (or 50 times). When “washing” is used herein, it may refer to any suitable form of washing a garment, textile or fabric, such as hand washing or machine-washing. More particularly, “washing” refers to subjecting the garment, textile or fabric to a suitable machine wash cycle for that particular item. For example, for an item of sportswear, the item may be subjected to a pre-programmed sportswear machine washing cycle at 40° C.

While the embodiments of the light guide element in FIGS. 3 to 5A below relate to a core and coating material, it will be appreciated that only a core silicone or polyurethane polymer is necessary for the light guide element to function. It will be appreciated that the light guide element may be made of a silicone or polyurethane polymer that has the property of total internal reflection or has the property of light scattering along the entire length of the elongated material of the light guide element. Examples of how this may be achieved are discussed hereinbelow.

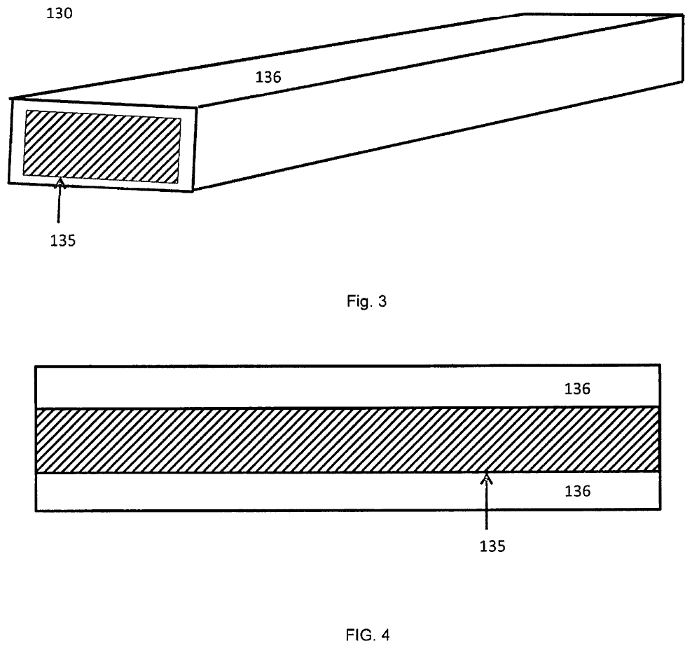

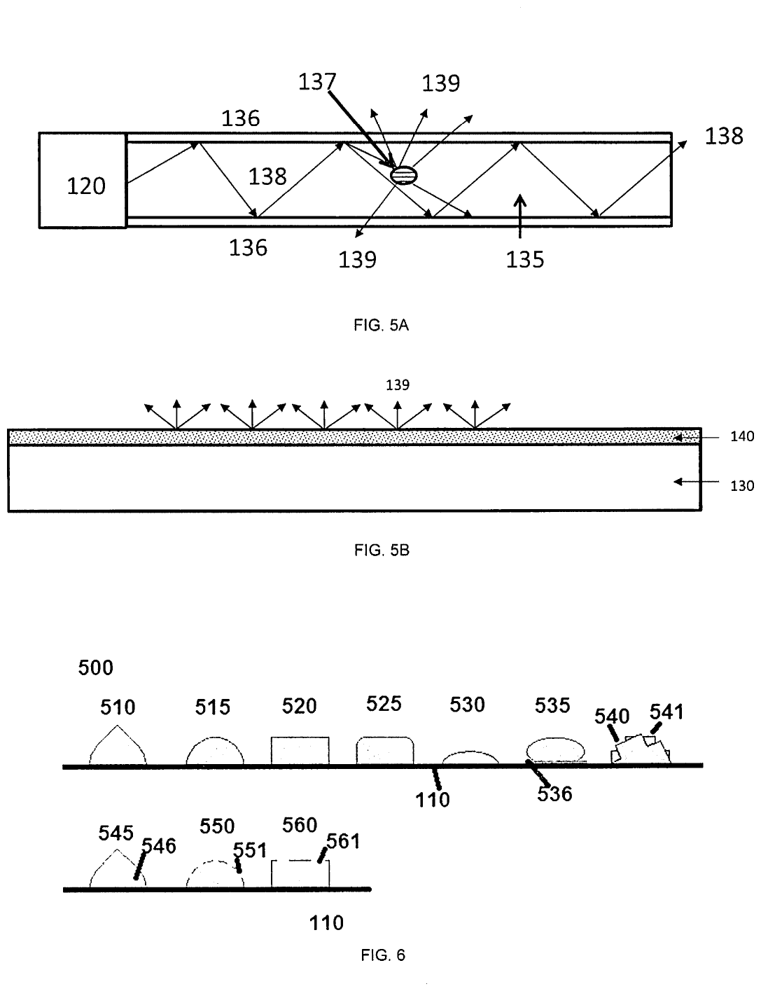

FIG. 3 depicts a possible light guide element of the current invention. This light guide element comprises a core silicone material with a low refractive index 135 (e.g. a poly[oxy(dimethylsilylene)] polymer having a refractive index of from 1.40 to 1.42) and a covering silicone material 136 with a lower refractive index (e.g. a poly[oxy(dimethylsilylene)] polymer where a methyl group in some of the dimethylsilylene repeating units of the polymer have been replaced by a trifluoropropyl group, which has a refractive index of from 1.30 to 1.42). It will be appreciated that the material used to make the light guide may be polymethylmethacrylate or polyurethane instead. FIG. 4 shows a longitudinal cross-section of the light guide element of FIG. 3. FIG. 5A depicts the light path 138 taken by light generated by a light source 120 through the light guide element described in FIGS. 3 and 4, with the addition of an inclusion material 137. As shown, the combination of a low and high refractive index material may result in total internal reflection along the length of the light guide element until the light meets with the inclusion material 137 which may result in at least some of the light being scattered 139 and providing light at that area.

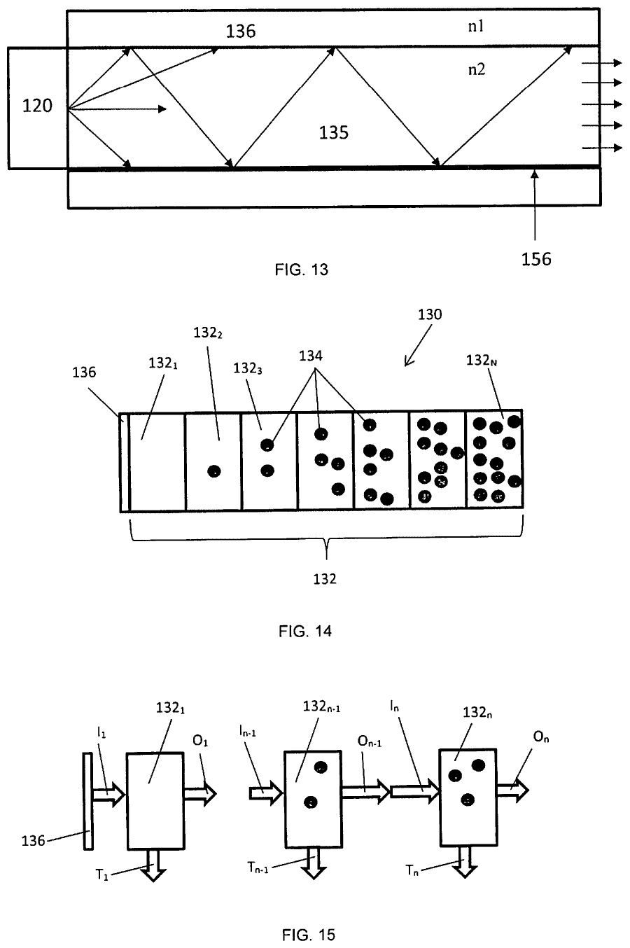

FIG. 13 depicts a light guide element according to the current invention, wherein there is a coating silicone material 135 with a refractive index n₁ and a core material made of silicone 136 with a refractive index n₂. It will be appreciated that the coating material may simply be air. In accordance with Snell's Law, when n₁/n₂ is less than or equal to 1 there is total internal reflection, thus in certain light guides of the invention having total internal reflection, the coating material has a refractive index that is less than the refractive index of the core material.

FIG. 5B depicts an alternative embodiment, wherein the light guide element 130 further comprises a diffuser element 140 which may contain inclusion materials, defects and the like. It will be appreciated that a combination of inclusion materials and defects may be sued. For example, there may be inclusion materials within the diffuser element 140 and defects (e.g. laser-cut holes or divots) on the exposed surface of the diffuser element. The diffuser element may be made from the same material as the light guide element 138 and may have a similar refractive index to allow light to enter and be diffracted by the inclusions/defects.

In alternative embodiments of the current invention, the diffusion coating provided in FIG. 5B may instead be a light-induced material that may fluoresce or otherwise interact with the light provided by the light source via the light guide element 130. In addition, it will be appreciated that the layer of diffusion layer/light induced material does not need to cover the entirety of the light guide element. That is, there may be a single section of diffusion/light induced material layer covering a single portion of the light guide element, or there may be multiple sections of diffusion/light induced material layer covering a multiple portions of the light guide element, for example in order to provide a patterned lighting effect.

In yet another alternative embodiment of the current invention, FIG. 14 depicts a light guide element 130 having a silicone polymer surface, wherein light is dispersed/diffracted through the surface. The light guide element 130 is demarcated into a finite number N of contiguous strips or bands 132. The bands 132 have identical dimensions, e.g. same width, thickness, shape, and size. Each band 132 contains none or a number of inclusion materials, defects, holes, divots, and the like (collectively referred to as inclusions 134). For example, the first band 132₁ contains zero inclusions 134 while each of the remaining bands 132₂, 132₃, and until 132_{N} contains one or more inclusions 134. It will be appreciated that n is a positive integer and refers to the ordinals/positions of the bands 132. The inclusions 134 are disposed on the surface of the light guide element 130 to facilitate dispersion/diffraction of light emitted from a light source 136 and entering the light guide element 130.

A selection of the bands 132 comprising the first band 132₁ without inclusions 134, as well as generic bands 132ₙ₋₁ and 132ₙ within the N number of bands 132 (i.e. n≤N), is depicted in FIG. 15. For nth band 132ₙ, the amount of light entering the band 132ₙ, i.e. input light, is indicated as Iₙ, while the amount of light leaving the band 132ₙ, i.e. output light, is indicated as Oₙ. As the bands 132 are contiguously linked, the input light Iₙ for nth band 132ₙ is equal to the output light Oₙ₋₁ for the preceding (n−1)th band 132ₙ₋₁.

As light propagates through a band 132, some light is dispersed by the silicone polymer material of the surface as well as by the inclusions 134. As such, the input and output light for a band 132 will not be equal. For nth band 132ₙ, the total light dispersed out of the band 132ₙ or total light dispersion Tₙ is the sum of dispersion Mₙ due to the surface material and dispersion Sₙ due to the inclusions 134.

Tₙ=Mₙ+Sₙ

As the light guide element 130 is configured for uniform light output along its length, the value of T for each band 132 is approximately the same. Accordingly, Tₙ is a substantially constant value for each band 132, including the value T₁ for the first band 132₁.

Tₙ=T₁

The first band 132₁ contains zero inclusions 134 and thus there is no light dispersion due to such inclusions 134, i.e. S₁=0. The total light dispersion at the first band 132₁ is caused mainly by the surface material.

T₁=M₁

For nth band 132ₙ, due to the silicone polymer material of the surface, the output light Oₙ is reduced to a factor C of the input light Iₙ and the light loss is dispersed as Mₙ, wherein C is a positive number less than 1.

Oₙ=CIₙ,C∈R,0<C<1

Mₙ=(1−C)Iₙ

As the value of T is substantially constant for each band 132, the values of T for the first band 132₁ and nth band 132ₙ are the same.

Tₙ=T₁=M₁=(1−C)I₁

For a contiguous series of bands 132 from the first band 132₁ to the (n−1)th band 132ₙ₋₁, the total light dispersed is a summation of T₁, T₂ . . . to Tₙ₋₁, each of which is a substantially constant value.

$${\sum }_{i = 1}^{n - 1} {T}_{i} = ( n - 1 ) {T}_{1}$$

For the succeeding nth band 132ₙ after the series of bands 132₁ to 132ₙ₋₁, the input light Iₙ is equal to the output light Oₙ₋₁ from the preceding (n−1)th band 132ₙ₋₁. The output light Oₙ₋₁ is the remaining light from the light source 136 after the dispersion of light across the series of bands 132₁ to 132ₙ₋₁.

$${O}_{n - 1} = {I}_{1} - {\sum }_{i = 1}^{n - 1} {T}_{i}$$

$${O}_{n - 1} = {I}_{1} - ( n - 1 ) {T}_{1}$$

$${I}_{n} = {I}_{1} - ( n - 1 ) ( 1 - C ) {I}_{1}$$

$${I}_{n} = [ 1 - ( n - 1 ) ( 1 - C ) ] {I}_{1}$$

For nth band 132ₙ, due to the silicone polymer material of the surface, the output light Oₙ is reduced to a factor C of the input light Iₙ and the loss light is dispersed as Mₙ.

Oₙ=Iₙ−Mₙ

Mₙ=(1−C)Iₙ

Mₙ=[1−(n−1)(1−C)](1−C)I₁

The total light dispersion Tₙ (also equal to T₁) is the sum of dispersion Mₙ due to the surface material and dispersion Sₙ due to the inclusions 134.

Tₙ=Mₙ+Sₙ

Sₙ=T₁−Mₙ,Tₙ=T₁

Sₙ=T₁−[1−(n−1)(1−C)](1−C)I₁

Sₙ(1−C)I₁−[1−(n−1)(1−C)](1−C)I₁

Therefore, for nth band 132ₙ, the dispersion Sₙ due to the inclusions 134 is calculated as:

Sₙ=(n−1)(1−C)²I₁,n∈Z,n≥1

Notably, for the first band 132₁ wherein n=1, S₁=0 as there are no inclusions 134 and thus no light dispersion due to such inclusions 134.

As stated above, for nth band 132ₙ, the dispersion Mₙ due to the surface material is:

Mₙ=[1−(n−1)(1−C)](1−C)I₁

However, this equation is derived under the assumption that the factor C for each band 132 is constant. The factor C will be constant if each band 132 has the same area of the surface material. Most bands 132 contain inclusions 134 that occupy some of the area of the surface material. Due to each band 132 having identical dimensions and the presence of inclusions 134 on most bands 132, the area of the surface material for each band 132 is not constant. Consequently, the factor C is not constant for each band 132.

The equation for the dispersion Mₙ can be improved or better expressed by factoring in the actual area of the surface material as a fraction of the total surface area for each band 132, while keeping the factor C constant. Each band 132 has the same dimensions and constant total surface area, A. For nth band 132ₙ, the actual area of the surface material is given as Wₙ and the area occupied by the inclusions 134 is given as Vₙ.

A=Vₙ+Wₙ

For nth band 132ₙ, a more accurate representation of the dispersion Mₙ due to the surface material and after factoring in the actual area Wₙ of the surface material is calculated as:

$${M}_{n} = \frac{{W}_{n}}{A} [ 1 - ( n - 1 ) ( 1 - C ) ] ( 1 - C ) {I}_{1}$$

$${M}_{n} = \frac{{A}_{n} - {V}_{n}}{A} [ 1 - ( n - 1 ) ( 1 - C ) ] ( 1 - C ) {I}_{1}$$

Consequently, the dispersion Sₙ due to the inclusions 134 is calculated as:

$${S}_{n} = {T}_{n} - {M}_{n}$$

$${S}_{n} = {T}_{1} - {M}_{n} , {T}_{n} = {T}_{1}$$

$${S}_{n} = {T}_{1} - \frac{A - {V}_{n}}{A} [ 1 - ( n - 1 ) ( 1 - C ) ] ( 1 - C ) {I}_{1}$$

$${S}_{n} = ( 1 - C ) {I}_{1} - \frac{A - {V}_{n}}{A} [ 1 - ( n - 1 ) ( 1 - C ) ] ( 1 - C ) {I}_{1}$$

$${S}_{n} = \{ 1 - \frac{A - {V}_{n}}{A} [ 1 - ( n - 1 ) ( 1 - C ) ] \} ( 1 - C ) {I}_{1}$$

The area occupied by each inclusion 134 is given as constant d and the number of inclusions for nth band 132ₙ is given as Xₙ.

$${V}_{n} = {X}_{n} d$$

$${S}_{n} = \{ 1 - \frac{A - {X}_{n} d}{A} [ 1 - ( n - 1 ) ( 1 - C ) ] \} ( 1 - C ) {I}_{1}$$

$${S}_{n} = \{ 1 - [ 1 - \frac{{X}_{n} d}{A} ] [ 1 - ( n - 1 ) ( 1 - C ) ] \} ( 1 - C ) {I}_{1}$$

The light dispersion for each inclusion 134 is given as D.

$${S}_{n} = {X}_{n} D$$

$${X}_{n} D = \{ 1 - [ 1 - \frac{{X}_{n} d}{A} ] [ 1 - ( n - 1 ) ( 1 - C ) ] \} ( 1 - C ) {I}_{1}$$

$${X}_{n} = \{ 1 - [ 1 - \frac{{X}_{n} d}{A} ] [ 1 - ( n - 1 ) ( 1 - C ) ] \} ( \frac{1 - C}{D} ) {I}_{1}$$

$${X}_{n} = \frac{( n - 1 ) {( 1 - C )}^{2} {I}_{1}}{D - \frac{d}{A} [ 1 - ( n - 1 ) ( 1 - C ) ] [ 1 - C ] {I}_{1}}$$

Accordingly, for nth band 132ₙ, the number of inclusions 134, Xₙ, is dependent on several variables, namely n, C, D, d, A, and I₁. As the values of C, D, d, A, and I₁ are pre-determinable and constant, the value of Xₙ is dependent on the value of n. It will be appreciated from this equation that as n increases, Xₙ increases accordingly. In other words, for nth band 132ₙ, the number of inclusions 134 increases along the length of the light guide element 130, i.e. with the distance from the light source 136 at one end of the light guide element 130. More specifically, the density of inclusions 134 in a band 132 is positively associated with the ordinal or position of the band 132, i.e. the density of the inclusions 134 for each band 132 increases across successive bands 132. For example, for second band 132₂ and third band 132₃, the density of inclusions 134 is greater for the third band 132₃ than for the second band 132₂.

It will be appreciated that the above may be adapted to apply to a light guide that has a light source at both ends, or a light source encapsulated part-way along the light guide providing two-directional light, or a light source at one end of the light guide and a further light source encapsulated part-way long said light guide (e.g. providing one- or two-way directional light) and any other suitable arrangement of light sources and light guides that may be formed following the teaching of this document.

FIG. 6 depicts various cross-sections that the light guide element may have when affixed to the surface of the flexible and stretchable substrate. As shown, the cross sections can be quadrilateral (520, 560), quadrilateral with one or more curved edges (525), semi-circular (515, 550), semi- or partly-elliptical (530, 535), and cruciform (540).

The cross-section may be distorted by the formation of at least one peak on a surface that is not attached to the substrate, as is illustrated by 510 where a semicircular cross-section has been distorted to form a peak. Such peaked/angled cross-sections serve to create an optical line of light at the peak. The same may be true for light guide elements with a quadrilateral or cruciform cross-section. In contrast, a quadrilateral cross-section with one or more curved edges as exemplified by 525 in FIG. 6, may help to ensure less scattering of light and ensure more of the light transfers through the light guide element. This conservation of light may also hold true for the cross-sections that present a curved cross-section.

As shown by 540 in FIG. 6, when the cross-section is cruciform, the light guide element may oscillate in a repeating cruciformal pattern, such that a cruciform cross-section taken at a first point 541 of the repeating pattern is offset compared to a cross-section taken at a second point 540 of the repeating pattern. This may create a pleasing aesthetic scattering of light and therefore illumination.

In order to ensure the scattering of light through the entire length of the light guide element, or within sections thereof, the substance that forms the light guide may further comprise one or more materials that form inclusions in the silicone or polyurethane polymer. This is depicted in 545 of FIG. 6, which contains multiple inclusion materials 546. Additionally or alternatively, the exposed surface (i.e. the surface not attached to the substrate) may contain one or more pits or channels (e.g. grooves) to achieve light scattering too, thereby providing illumination. The cross-sectional profile 550 provides an example of pits 551, while cross-sectional profile 560 provides an example of grooves 561.

In certain circumstances, the light transporting properties of the light guide element may be enhanced by the application of a light reflective base material affixed to the substrate and between the substrate and the light guide. This is shown in cross-sectional profile 535 of FIG. 6, which is fixed to the substrate 110 by a reflective material 536. In additional or alternative embodiments, the light guide element may further comprise a reflective coating material across at least part of the elongated material of the light guide to achieve a similar improvement in light transportation when required.

In order to ensure that the light guide element does not impede the user, the light guide element in particular embodiments of the invention may have:
(a) a stretchability of from 0 to 300% (e.g. from 10 to 250%, such as from 50 to 150%); and/or
(b) a thickness of from 0.5 mm to 100 mm; and/or
(c) a width of greater than or equal to 0.5 mm.

The light guide element can be integrated into a flexible and stretchable substrate by any suitable means. Suitable methods of integration are discussed in more detail below.

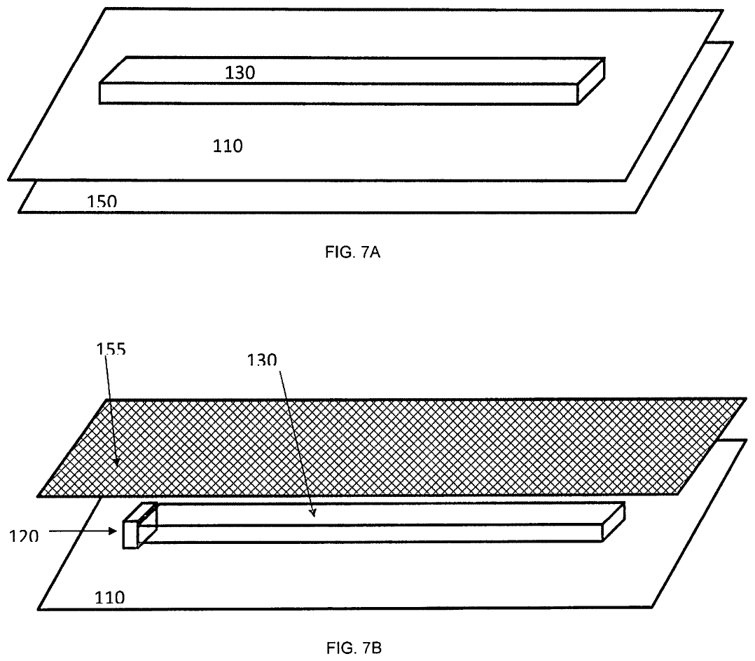

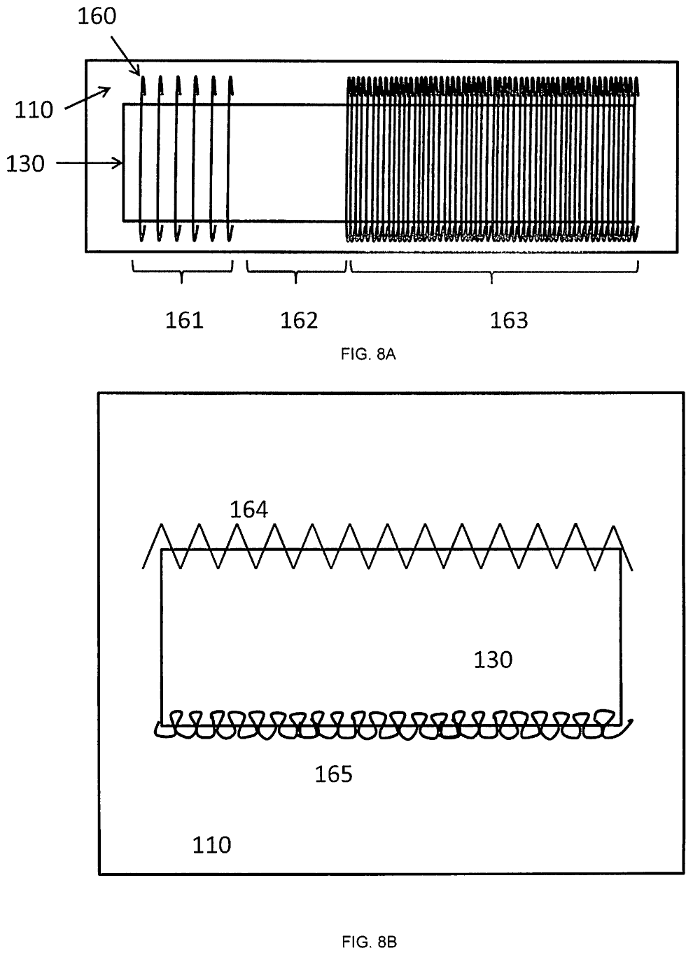

In the simplest method, the integration may be achieved by simply applying the light guide in an uncured state onto the first substrate. This may be accomplished by any suitable means, such as, but not limited to, screen printing that is then followed by curing by any suitable method, such as, but not limited to, light curing, heat curing or chemical curing. A light guide element prepared in this manner is depicted in exploded form in FIG. 7A, in which the light guide 130 is bonded to the first substrate 110 in an uncured state and then cured. In certain embodiments, for example where the first substrate does not form the entirety of the product, a bonding film 150 may be incorporated on the surface of the first substrate 110 opposite to the surface there the light guide element 130 is bonded. It will be appreciated that this integration technique may be particularly suitable for light guide element materials that have an adhesive quality in their uncured state, such as silicone.

In a modification of the embodiment of FIG. 7A where bonding film is not included, a mesh or clear fabric/material (e.g. a plastic film) may be applied as a cover 155 over the light guide element 130, the light source 120 and at least part (or all) of the first substrate 110 as depicted in exploded FIG. 7B. It will be appreciated that this covering 155 may be compatible for use with other embodiments discussed hereinbelow.

In other embodiments, the light guide element may be integrated into a flexible and stretchable substrate by use of stitching, such that the light guide element is permanently fixed to the substrate. This may be by an embroidery stitching method, where the light guide element is not penetrated by the stitches/thread, as shown in FIG. 8A or by a stitching method, such as chain or zig-zag stitches, where the stitches/thread penetrates the light guide element, as shown in FIG. 8B.

As shown in FIG. 8A the embroidery stitching method involves stitching into the substrate 110 and around the light guide element 130 to hold the latter in place. As shown, the embroidery method may be conducted in numerous ways. For example, the stitches can be placed in a manner that they do not obscure the presence of the light guide element as shown by section 161 of FIG. 8A. In this arrangement, the light guide element 130 is visible through the embroidered stitches even when no light is shining through the light guide element. Alternatively, when no light is passing through the light guide element 130, the light guide element may be entirely hidden by the embroidered stitches, as depicted by section 163 of FIG. 8A, which features a greater density of stitches to cover and obscure the light guide element, while still enabling light to shine through. It will be appreciated that not all areas of the light guide element need to be covered in embroidered stitches. Thus, in a yet further possibility, part of the light guide element 130 may have no stitches, such as section 162, while other sections (e.g. 161 and 163) are covered by stitches.

In FIG. 8B, two methods of stitching that penetrate the light guide element are provided. These include the zig-zag stitch 164 and the chain stitch 165, which penetrate the light guide element 130 and the flexible and stretchable substrate 110. As will be appreciated, these stitches are not capable of hiding the light guide element 130, but they do introduce holes (i.e. defects) into the light guide element 130, such that light may escape from the light guide element to create a glowing effect along the stitched length. It will be appreciated that any suitable form of stitching that penetrates the light guide element 130, while leaving it relatively uncovered and visible on the substrate 110 may be used.

In a variation on the embroidery stitch described above in respect of FIG. 8A, loops may be used instead in a manner similar to a belt to hold the light guide element in place on the substrate. In this case, the light guide element may be permanently held in position (e.g. in the form of a continuous loop itself) by the loops, or removably held in place (e.g. like a belt). The loops may be made of the same material as the substrate or any other suitable material (e.g. a fabric, textile or polymer) and may be bonded by any suitable means (e.g. stitching, heat-bonding, gluing and the like).

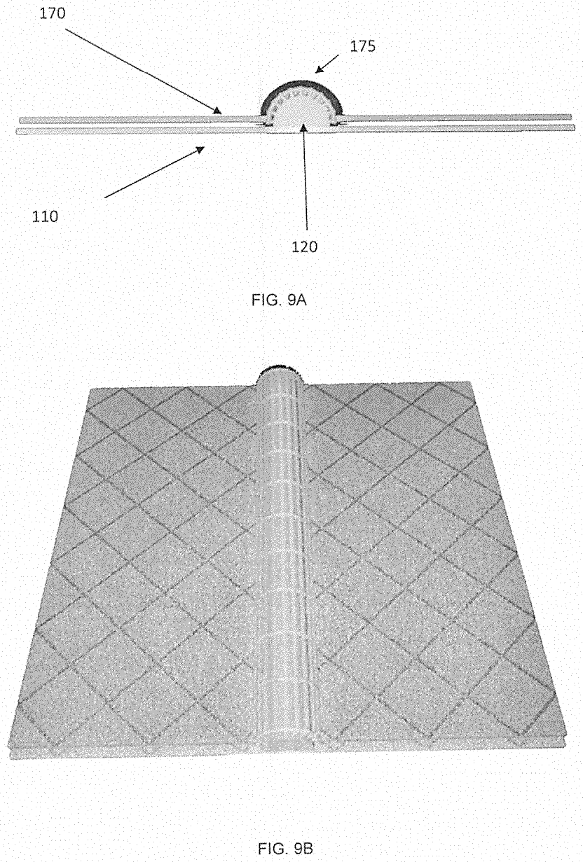

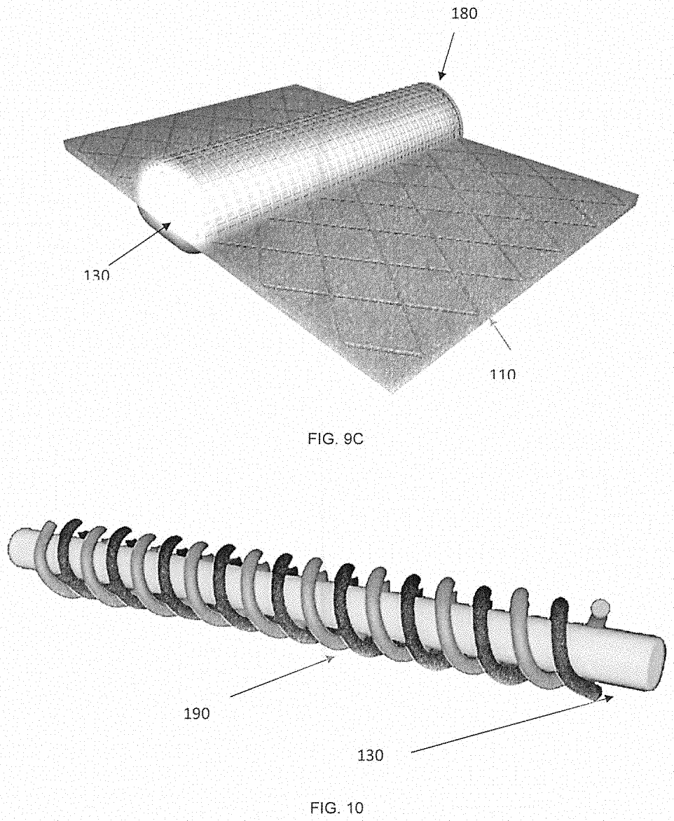

In further embodiments of the invention, the light guide may be hidden from view by use of an opaque material that obscures the light guide element when not in use, but allows light to shine through the light guide element when the light guide is in operation. One possible embodiment of this arrangement is depicted in FIG. 9A in cross-section, wherein a moulded fabric layer 170 containing a molded section 175 is overlaid onto the first substrate 110 and light guide element 130 (and other elements of the light guide (not shown). As depicted in FIG. 9B in perspective view, the light guide may be semi-cylindrical in nature and is covered by a fabric that contains a section moulded to conform to the light guide.

A similar effect to that described in relation to FIGS. 9A and 9B may be achieved by the use of 3D-knitting as shown in FIG. 9C. In this case, a pocket 180 may be obtained in the first substrate 110 by selective patterning of the yarns used in the knitting process to house the light guide element and the other components. As the pocket 180 is created using one or more of the yarns used to manufacture the first substrate 110, the material is opaque and obscures the light guide element from view when not in operation. However, when the light guide element 130 is illuminated, the light is visible through the material of the pocket 180.

As the light guide element used herein is flexible and stretchable, it may be used as part of a yarn construction and directly integrated into knitted and/or woven substrates. This is depicted in FIG. 10, where the light guide element 130 is covered in yarn 190 and can be integrated directly into the first substrate.

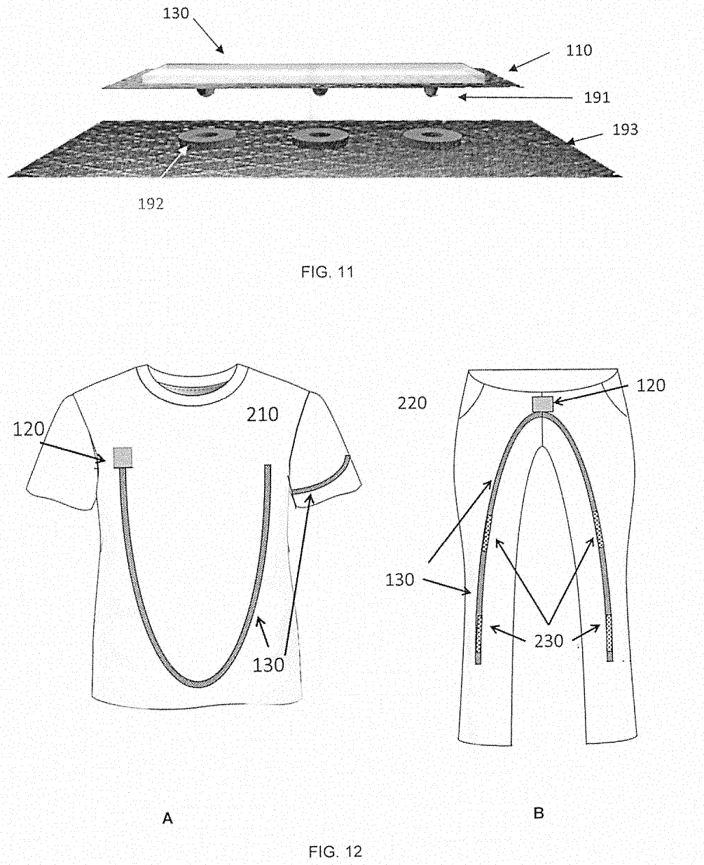

In certain embodiments of the invention, it may be convenient to have a removable light guide that can be placed on different parts of a product, such as a garment or used interchangeably between products such as garments. One possible arrangement to achieve this is shown in FIG. 11 where the first substrate 110 contains one or more male snaps 191 that complement female snaps 192 on a second substrate 193 that forms part of a larger product (e.g. a garment). As shown, the male snaps 191 are on an opposite side of the first substrate 110 to the light guide element. It will be appreciated that the male snaps may be on the second substrate, while the female snaps are on the first substrate or that the male and female snaps may be mixed together to provide particular locking patterns. While snaps are described herein, any other suitable method may be used, such as the use of complementary magnets.

FIG. 12 depicts examples of the invention wherein the substrate is a fabric or textile and has been formed into at least part of a garment, though the light guide device may be equally applied to manufacture a toy or a vehicle lighting system (e.g. for the interior of a car). The T-shirt 210 of FIG. 12A contains an encapsulated lighting source 120 that directs light through the entire length of the light guide element 130 and where scattering occurs along the entire length of the light guide element. In practice however, it may be necessary to use a high-intensity light source or to include multiple light sources in the light guide garment 210 if the light guide is more than around 20 cm in length. Such an arrangement has been described above in relation to FIG. 1. Trousers 220 of FIG. 12B contain an unencapsulated light source 120 that provides light through a split light guide element 130 that only provides light scattering at defined areas 230, which can be achieved by using any of the options provided herein.

To manufacture a light guide device as described herein, a flexible and stretchable substrate is provided and a light source is attached thereto. Following which, the silicone or polyurethane polymeric composition that forms light guide element is attached to the flexible and stretchable substrate by one or more of screen printing, stencil application, injection molding, pour molding, and direct extrusion and is then cured. This ordering of attachment is particularly useful when the light source is to be encapsulated within the light guide element. It will be appreciated that the order of addition of elements can be changed when the light source is not encapsulated. Further, it will be appreciated that more than one polymeric composition may be applied in a situation where a core material is coated in another polymeric material.

It will be appreciated that the light source used herein will require a driving mechanism to provide it with power, and to potentially control the intensity and type of light that is produced from the light source (e.g. constant or pulsatile lighting). Any suitable driving source may be used. An example of a suitable driving source is provided by a battery connected to the light source by any suitable conductive connection, as is known in the art.

While certain novel and inventive features of this invention have been shown and described hereinbefore and are pointed out in the claims, it will be understood that various omissions, substitutions and changes in the forms and details of the device illustrated and in its operation can be made by those skilled in the art without departing from the spirit of the invention and/or the scope of the claims.

1. A light guide device comprising:
a first flexible and stretchable substrate;
one or more light sources; and
a first flexible and/or stretchable light guide element, wherein the light guide is:
an elongated material, that has a first end and a second end distal to the first end, that is attached to the first substrate, the first end is adjacent to and/or covers at least one of the one or more light sources; and
made from a substance that comprises a polymer, wherein the polymer is selected from the group consisting of a silicone polymer, a polyurethane polymer and a polymethylmethacrylate polymer.

2. The light guide device of claim 1, wherein at least one of the one or more light sources is encapsulated by the flexible and stretchable light guide element.

3. (canceled)

4. (canceled)

5. (canceled)

6. (canceled)

7. The light guide device of claim 1, wherein the substance that forms the light guide element further comprises one or more materials that form inclusions in the polymer, optionally wherein:
(a) the density of the inclusions increases with the distance from a light source; and/or
(b) the light guide element is demarcated into a number of contiguous bands, each band having zero or more of the inclusions, optionally wherein the bands have identical dimensions and the density of the inclusions for each band increases across successive bands.

8. The light guide device of claim 1, wherein the light guide includes defects or holes, optionally wherein the density of the defects or holes increases proportionately with the distance from a light source.

9. The light guide device of claim 1, wherein a surface of the light guide element not attached to the first substrate comprises one or more pits or channels, optionally wherein the density of the pits or channels increases proportionately with the distance from a light source.

10. (canceled)

11. (canceled)

12. The light guide device of claim 1, wherein the light guide device further comprises a light reflective substrate or a light reflective base material affixed to the first substrate and between the first substrate and the light guide element.

13. The light guide device of claim 1, wherein the light guide further comprises a reflective coating material across at least part of the elongated material of the light guide element, optionally wherein the reflective coating material is a silicone polymer, a polyurethane polymer or a polymethylmethacrylate polymer having a refractive index less than the material coated.

14. The light guide device of claim 1, wherein the light guide element is made of a polymer that has the property of total internal reflection.

15. The light guide device of claim 1, wherein the light guide element is made of a polymer that has the property of light scattering along the entire length of the elongated material of the light guide element.

16. (canceled)

17. The light guide device of claim 1, wherein at least part of at least one surface of the light guide element is covered by a diffusion material, optionally wherein the diffusion material is selected from the group consisting of a silicone polymer, a polyurethane polymer and a polymethylmethacrylate polymer that further comprises one or more holes, inclusion members, defects, pits and channels.

18. The light guide device of claim 1, wherein the light guide element is permanently attached to the first flexible and stretchable substrate, optionally wherein the permanent attachment is selected from direct attachment means and apparatus and, indirect attachment means and apparatus.

19. The light guide device of claim 1, wherein the light guide element is removably attached to the first flexible and stretchable substrate, optionally wherein the removable attachment is selected from one or more of the group consisting of a pocket to accommodate the light guide element, and fabric loops.

20. The light guide device of claim 1, wherein the first substrate is a fabric or textile.

21. (canceled)

22. The light guide device of claim 1, wherein the device further comprises a second flexible and stretchable substrate and an attachment means or apparatus to affix the first flexible and stretchable substrate to the second flexible and stretchable substrate.

23. The light guide device of claim 22, wherein:
(a) the second flexible and stretchable substrate is a fabric or textile, optionally wherein the fabric or textile forms the whole or part of a household decoration, furniture, a garment, a toy, an electronic device, or a vehicle lighting system; and/or
(b) the means or apparatus are complementary snap-fit devices on respective surfaces of the first and second flexible and stretchable substrates.

24. The light guide device of claim 1, wherein the device is capable of being washed up to 100 times without affecting the function of the light guide element.

25. (canceled)

26. The light guide device of claim 1, wherein the silicone polymer has a refractive index of from 1.30 to 1.60.

27. The light guide device of claim 1, wherein the silicone polymer is a poly[oxy(dimethylsilylene)] polymer, optionally wherein one or more methyl groups are replaced by trifluoropropyl groups or phenyl groups.

28. A method of making a light guide device of claim 1, which method comprises attaching a flexible and/or stretchable light guide element to a flexible and stretchable substrate by one or more of stitching, 3D knit based tunnelling, screen printing, stencil application, injection molding, pour molding, and direct extrusion.

29. The method of claim 28, wherein one or more of defects, holes, pits or channels are present, they are introduced to the light guide by the use of one or more of the group selected from laser etching, laser cutting, milling, and die cutting.

30. (canceled)

31. (canceled)

32. (canceled)

33. (canceled)

34. (canceled)
